(19) United States
(12) Patent Application Publication
(10) Pub. No.: US 2004/0078806 A1
(43) Pub. Date: Apr. 22, 2004

(54) System and method for displaying a summary menu of stored user profiles

(76) Inventors: Carolynn Rae Johnson, Indianapolis, IN (US); Anthony Edward Stuart, Indianapolis, IN (US); Marc Aaron Kiefer, Indianapolis, IN (US); Darrel Wayne Randall, Danville, IN (US)

Correspondence Address: Joseph S Tripoli, Thomson Multimedia Licensing Inc, PO Box 5312, Princeton, NJ, 08543-5312, US

(21) Appl. No.: 10/468,557

(22) PCT Filed: Feb. 28, 2002
(86) PCT No.: PCT/US02/06488

(51) Int. Cl. H04N 7/16; H04H 9/00

(52) U.S. Cl. 725/9; 725/14; 725/25; 725/28; 725/29

(57) ABSTRACT

A method for controlling viewing of television programs comprising storing user profile records comprising fields having values in a memory; providing a user interface having a list of the stored user profile records; and upon user command, displaying a stored user profile record in summary form in the user interface. Preferably, the user command comprises highlighting a stored user profile record in the list, resulting in the values of the highlighted stored user profile record being displayed in summary form in the user interface.

### FIELD OF THE INVENTION

This invention relates to the field of parental control television systems in general and, in particular, to editing, creating, and displaying user profiles associated therewith.

### BACKGROUND OF THE INVENTION

Due to the advent of cable television, direct satellite systems, and other television program broadcast systems, television viewers have very large numbers of programs from which to select. Many of these programs are not suitable for younger or immature viewers due to content, violence, language, nudity, etc. As such, parents having children or immature viewers in their household may wish to make these programs inaccessible to a specific viewer.

In addition to blocking certain programs, parents may want to exercise additional restraints over their children's television viewing habits, including: (1) how much time a specific viewer is allowed to watch TV on weekdays or weekends; (2) how much money a specific viewer can spend on pay-per view programming per program or per month; (3) whether a specific viewer should have access to a specific channel; and (4) the hours during which a specific viewer can access satellite programming for weekends or weekdays. Because parents can not constantly be monitoring their children and/or the less mature viewers in their household, sophisticated systems have been developed to assist parents in achieving their desired control.

Many of these systems utilize Electronic Program Guide (EPG) systems, including their hardware, software, and downloading and storage capabilities. An EPG is an interactive, on screen equivalent to TV listings found in local newspapers or other print media. An EPG can provide up to 20 different kinds of information about each program that is within the time frame covered by the EPG. In a typical EPG system, an electronic host device stores records corresponding to upcoming television programs that are within the EPG's time frame. Each record contains program identification data that is unique to a particular upcoming television program. The program identification data can include program title, start time, end time, duration, rating, time remaining, content, cost, topic, theme, actors, writer, production studio, awards, keywords, release date, director, and a brief description. The records are updated periodically by both deleting records of programs that have previously aired and adding new records of upcoming programs that fall within the EPG's time frame as time passes.

U.S. Pat. No. 5,515,106, Chaney, describes a data packet structure necessary to implement an EPG system. The data packet structure is designed so that both the channel information (e.g., channel name, call letters, channel number, type, etc.) and the program identification information (e.g., content, title, rating, star, duration, cost, etc.) relating to a program may be transmitted from a program guide database provider to a receiving apparatus such as a television efficiently.

Parental control systems are often incorporated into EPG systems, using the same hardware, software, and stored EPG program records to facilitate parental control. Such systems make parental control possible by utilizing the concept of user profiles. In parental control systems utilizing user profiles, a parent establishes a user profile for a specific viewer. In setting up a particular user profile, the parent establishes television viewing restraints for the user associated with that user profile. That user's television viewing capabilities are dictated by the limitation set by the parent in that particular user's profile. In such systems, a user must “log on” as an established user in order to watch television. As such, the parental control system is programmed to implement the limitations associated with that user's profile, not only blocking out certain programs or channels, but also tracking and recording television viewing statistics of that user in order to implement various limitations. This is facilitated in part by the ability of the parental control system to analyze the data of the EPG records for the currently stored programs.

In existing parental control systems, if a system owner (i.e., the parent) chooses to set up all limits possible for a new profile, he or she will have to create a multitude of settings, including: establishing movie rating limits, TV rating limits, limits for D S L V FV content; determining whether or not to permit viewing of programs that have not been rated for content; establishing a per-event spending limit and a monthly spending limit; establishing a maximum number of viewable hours for weekends and weekdays; establishing hours during which satellite programming can be viewed for weekends and weekdays; and establishing channel lists which determines whether to block or allow access to specific channels (currently there are over 200 channels).

A system owner creates a new user profile by accessing a user interface adapted for creating new user profiles. The user interface for creating new user profiles typically comprises a plurality of user settings buttons. Upon selecting a user settings button, a screen corresponding to that user settings button is displayed in the user interface. Each user settings button has a separate screen associated with it. Each screen has one or more fields for data entry corresponding to one of the viewing limitation mentioned above. By inputting variables into the fields, the system owner sets the viewing limitations associated with those fields. Once the system owner has accessed the desired limitation screens and entered values in the desired data fields, he or she can save the user profile to a local non-volatile memory.

However, a system owner may subsequently wish to modify some or all of the settings established in a stored user profile. If the system owner decides that he or she wishes to modify any of the settings established in a stored user profile, the system owner accesses a user interface adapted for editing stored user profiles. This interface has a list of user names, each name corresponding to one of the stored user profiles. In order to evaluate whether the settings of a particular user need to be modified, it is necessary for the system owner to know what the current settings for that particular user profile are. However, in existing parental control systems, the only way a system owner can view the settings for a stored user profile is to select the name corresponding to that user profile and then access every limitations screen associated with that profile (as discussed above). Thus, in order to determine whether or not particular settings need to be modified, the system owner must spend considerable amounts of time accessing each limitations screen. Moreover, this often results in the system owner accessing limitations screens only to find out that the current settings within that screen do not need to be changed. This is a waste of the system owner's time and effort.

Additionally, a user profile also stores personal settings for a user, such as the identity of the default guide to be used, how the guide is to be sorted, color settings, translucency setting, animation settings, fetch settings, and whether “help” information is disabled or enabled. These attributes of a user profile are created and edited in a manner similar to that of the parental control settings. As such, the same problem of wasting time exists with respect to editing personal settings as exists with editing parental control settings. Thus, a need exists to be able to quickly review settings for stored user profiles, including parental control settings and personal settings.

### SUMMARY OF THE INVENTION

These problems and others are solved by the present invention which in one aspect is a method for controlling viewing of television programs comprising storing user profile records comprising fields having values in a memory; providing a user interface having a list of the stored user profile records; and upon user command, displaying a stored user profile record in summary form in the user interface.

Preferably, the user command is highlighting a stored user profile record in the list, resulting in the values of the highlighted stored user profile record being displayed in summary form in the user interface.

Also preferably, the method further comprises the-step of upon a second user command, accessing a second user interface for editing the values of the displayed stored user profile record.

The fields can be one or more parental control fields. Preferably, the one or more parental control fields are selected from the group consisting of ratings limit, viewing hour limit, spending limit, user profile locked status, and blocked channels. The fields can also be one or more personal settings fields. Preferably, the one or more personal settings field are selected from the group consisting of default guide, guide sorting, color scheme, translucency, animation, fetch, and information help.

It is preferable that the user profile record is displayed in summary form on the user interface in a format wherein the values are displayed next to headings corresponding to the fields.

In another aspect, the invention is an apparatus for controlling viewing of television programs comprising a memory storing user profile records; a user interface for displaying a list of the stored user profile records and a summary of current settings for the stored user profile records; means for entering user commands; and wherein upon a user command, a summary of current settings for a stored user profile record is displayed in the user interface.

Preferably, the user command is highlighting a stored user profile record in the list, resulting in a summary of the current settings for the highlighted stored user profile record being displayed in the user interface.

Also preferably, the apparatus further comprises means for selecting the stored user profile record that is summarized in the user interface and accessing a second user interface for modifying the stored user profile record corresponding to the selected profile name. In such an embodiment, it is preferable that the second user interface comprise means for saving the modified user profile record in the memory.

Finally, it is preferable that the apparatus further comprise processor means for receiving user commands, getting stored user profile records from memory and generating corresponding display information in summary form, receiving and implementing user modifications to the stored user profile records, and storing the modified user profiles in the memory.

### BRIEF DESCRIPTION OF THE DRAWINGS

FIG. 1 is a schematic of an apparatus capable of processing user commands and displaying user interface screens in accordance with the present invention.

FIG. 2 is a schematic of a digital video processing apparatus suitable for processing user commands and displaying user interface screens in accordance with the present invention.

FIG. 3 is a schematic of a specific implementation of the apparatus generally shown in FIG. 2.

FIG. 4 is a display module having a diagrammatic representation of a prior art user interface for selecting a stored user profile to be edited.

FIG. 5 is a display module having a diagrammatic representation of a user interface for editing a stored user profile or creating a new user profile.

FIG. 6 is a display module having a diagrammatic representation of a user interface for selecting a stored user profile to be edited according to the present invention.

FIG. 7 is a flow chart of a method of displaying stored user profile setting in summarized form.

### DETAIL OF THE INVENTION

In order to understand the present invention, a detailed explanation of how a system owner creates and edits a user profile is necessary.

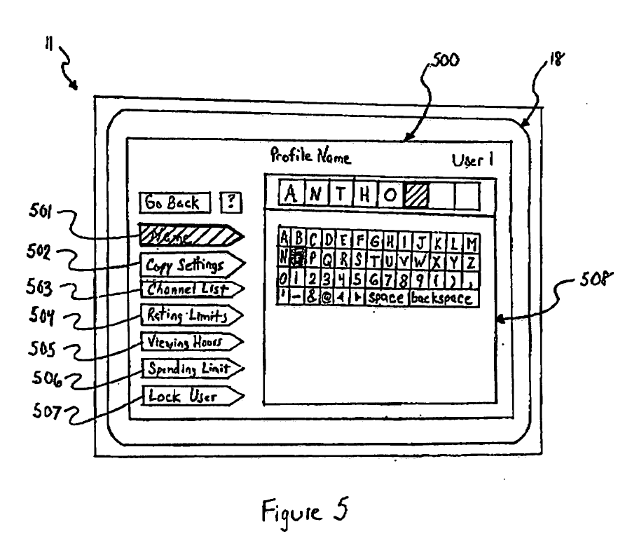

FIG. 5 illustrates display module 11 comprising display area 18 having user interface 500 displayed therein. Display module 11 is associated with an electronic host device having a non-volatile memory, a microprocessor, and an associated input command module (not illustrated). User interface 500 is adapted so that it can be used to either create new user profiles or edit established user profiles that are stored as records in the non-volatile memory.

User interface 500 comprises name button 501, copy settings button 502, channel list button 503, rating limits button 504, viewing hours button 505, spending limits button 506, and lock user button 507. User interface 500 further comprises control field 508. When a system owner highlights any of the buttons 501-507, a screen corresponding to the highlighted button appears in control field 508. Each screen has fields adapted to receive values that can be entered by the system owner. The values entered by the system owner in the fields make up the various settings/limitations for the profile being created, including: user identification; movie rating limits; TV rating limits; whether or not to permit viewing of programs that have not been rated for content; a per-event spending limit and a monthly spending limit; a maximum number of viewable hours for weekends and weekdays; hours during which satellite programming can be viewed for weekends and weekdays; channel lists which determines whether to block or allow access to specific channels; and whether the profile is to be locked or not.

When the system owner has completed entering values into the fields, he or she can then save the values/settings as a user profile record in the non-volatile memory. As saved, the user profile record comprises a plurality of fields corresponding to the viewing limitations that can be set. Within each field is the associated value entered by the system owner while interacting with user interface 500.

Once the user profile record is stored in the non-volatile memory, a user who logs on to the television system as the user associated with that user profile will be restricted by the limitations established therein. Howev r, it is possible that a system owner may decide at a later time that he or she wishes to modify/edit some of the viewing limitations established in the user profile.

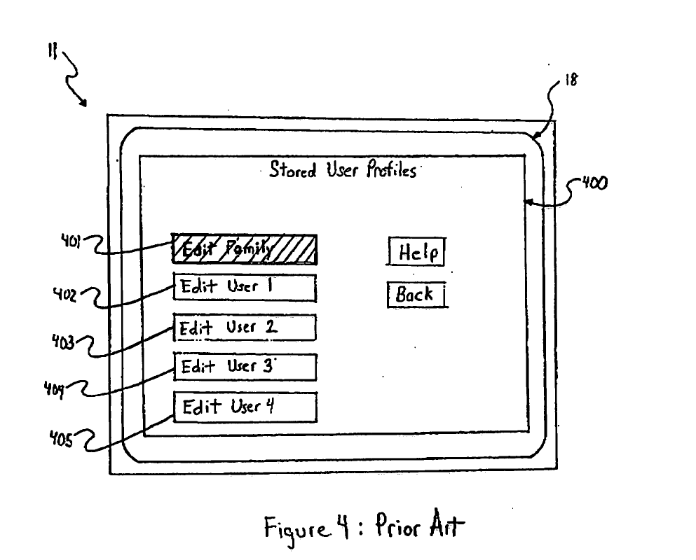

FIG. 4 illustrates a prior art interface for selecting an established user profile to be edited according to prior art methods. Display module 11 comprises display area 18 having user interface 400. A system owner accesses user interface 400 by activating an option to edit currently established user profiles (e.g., the option can be activated by making a selection in a different user interface or pressing a button on the input command module). User interface 400 contains user profile editing cells 401-405. Each user profile editing cell 401-405 contains the name of a previously created user profile that was saved and stored as a record in the non-volatile memory as discussed above. As such, user profile editing cells 401-405 effectively form a list of the all the stored user profile records that have been previously created by the system owner.

If the system owner knows that he or she wishes to modify the settings of a specific user profile, the system owner highlights and selects the user profile editing cell 401-405 that corresponds to that stored user profile. Upon selecting a particular cell 401-405, the user interface of FIG. 5 is displayed in display module 11. Simultaneously with the system owner accessing the user interface displayed in FIG. 5, the microprocessor gets the user profile record corresponding to the selected cell 401-405 and relates the saved values of the records to the corresponding fields of the screens associated with buttons 501-507 (FIG. 5). Thus, upon the system owner accessing one of the screens associated with buttons 501-507 (FIG. 4), the fields contain the values that were previously entered by the system owner for that user profile. Those values can then be edited and saved in a manner similar to the process discussed above for creating a new user profile.

However, when using the prior art interface of FIG. 4, if the system owner is unsure of whether he or she wishes to modify certain values of a user profile because he or she is unsure of the exact values entered in the fields, the system owner must access the interface of FIG. 4, select a user profile to edit, access the interface of FIG. 5, and then access each screen associated with creating the limits of that user profile. Only in this way can the system owner browse the stored values (i.e., the user profile settings) for a particular user profile. This takes a lot of time and effort on the system owner's part. This problem is solved by the present invention which is discussed in detail below.

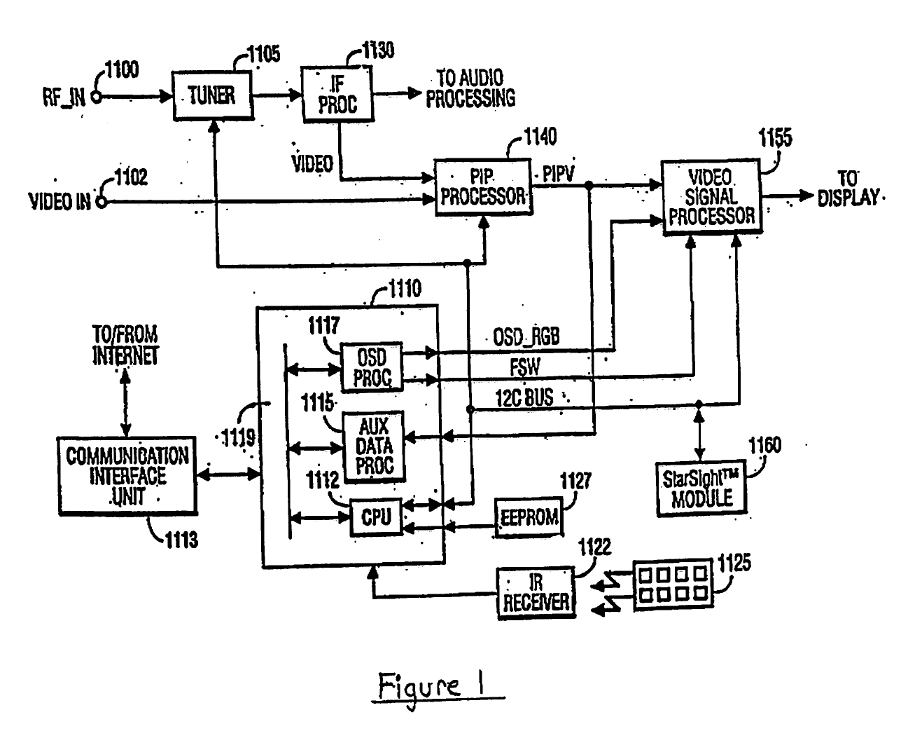

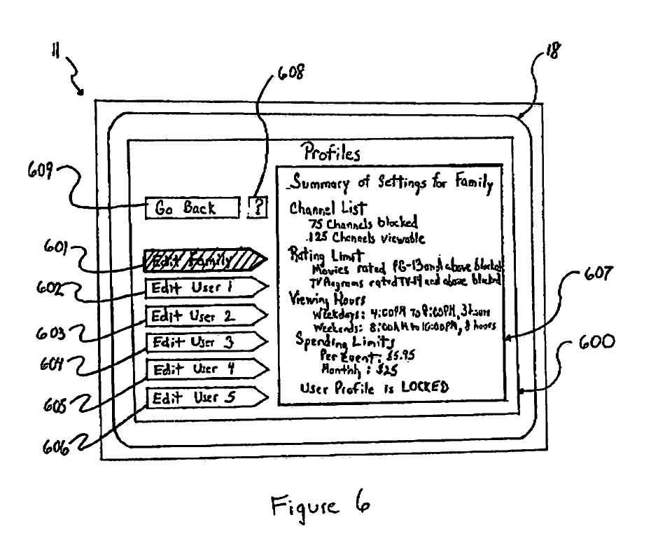

FIG. 1 is a schematic of an apparatus capable of processing user commands, displaying the user interface screens of FIGS. 5-6, and performing searches of stored program guide records in accordance with the present invention. The apparatus is capable of processing both analog NTSC television signals and internet information. The apparatus of FIG. 1 has a first input 1100 for receiving television signal RF_IN at RF frequencies and a second input 1102 for receiving baseband television signal VIDEO IN. Signal RF_IN may be supplied from a source such as an antenna or cable system while signal VIDEO IN may be supplied, for example, by a video cassette recorder (VCR). Tuner 1105 and IF processor 1130 operates in a conventional manner for tuning and demodulating a particular television signal that is included in signal RF_IN. IF processor 1130 produces baseband video signal VIDEO representing the video program portion of the tuned television signal. IF processor 1130 also produces a baseband audio signal that is coupled to an audio processing section (not shown in FIG. 1) for further audio processing. Although FIG. 1 shows input 1102 as a baseband signal, the television receiver could include a second tuner and IF processor similar to units 1105 and 1130 for producing a second baseband video signal from either signal RF_IN or from a second RF signal source.

The system shown in FIG. 1 also includes a main microprocessor (mP) 1110 for controlling components of the television receiver such as tuner 1105, picture-in-picture processing unit 1140, video signal processor 1155, and StarSight™ data processing module 1160. As used herein, the term “microprocessor” represents various devices including, but not limited to, microprocessors, microcomputers, microcontrollers and controllers. Microprocessor 1110 controls the system by sending and receiving both commands and data via serial data bus I²C BUS which utilizes the well-known I²C serial data bus protocol. More specifically, central processing unit (CPU) 1112 within mP 1110 executes control programs contained within memory, such as EEPROM 1127 shown in FIG. 1, in response to commands provided by a user, e.g., via IR remote control 1125 and IR receiver 1122. For example, activation of a “CHANNEL UP” feature on remote control 1125 causes CPU 1112 to send a “change channel” command along with channel data to tuner 1105 via I²C BUS. As a result, tuner 1105 tunes the next channel in the channel scan list. Another example of a control program stored in EEPROM 1127 is software for implementing the operations shown in FIGS. 5-6 and 7 (in flow chart form) in accordance with the present invention as to be described below.

Main microprocessor 1110 also controls the operation of a communications interface unit 1113 for providing the capability to upload and download information to and from the internet. Communication interface unit 1113 includes, for example, a modem for connecting to an internet service provider, e.g., via a telephone line or via a cable television line. The communication capability allows the system shown in FIG. 1 to provide email capability and internet-related features such as web browsing in addition to receiving television programming.

CPU 1112 controls functions included within mP 1110 via bus 1119 within mP 1110. In particular, CPU 1112 controls auxiliary data processor 1115 and on-screen display (OSD) processor 1117. Auxiliary data processor 1115 extracts auxiliary data such as StarSight™ data from video signal PIPV.

StarSight™ data which provides program guide data information in a known format is typically received only on a particular television channel and the television receiver must tune that channel to extract StarSight™ data. To prevent StarSight™ data extraction from interfering with normal use of the television receiver, CPU 1112 initiates StarSight™ data extraction by tuning the particular channel only during a time period when the television receiver is usually not in use (e.g., 2:00 AM). At that time, CPU 1112 configures decoder 1115 such that auxiliary data is extracted from horizontal line intervals such as line 16 that are used for StarSight™ data. CPU 1112 controls the transfer of extracted StarSight™ data from decoder 1115 via I²C BUS to StarSight™ module 1160. A processor internal to the module formats and stores the data in memory within the module. In response to the StarSight™ EPG display being activated (e.g., a user activating a particular key on remote control 125), CPU 1112 transfers formatted StarSight™ EPG display data from StarSight™ module 1160 via I²C BUS to OSD processor 1117.

OSD processor 1117 operates in a conventional manner to produce R, G, and B video signals OSD_RGB that, when coupled to a displayed device (not shown), will produce a displayed image representing on-screen display information in according to FIGS. 5-7 to be described later. OSD processor 1117 also produces control signal Fast-Switch (FSW) which is intended to control a fast switch for inserting signals OSD_RGB into the system's video output signal at times when an on-screen display is to be displayed. Therefore, when a user enables the various user interface screens of the present invention to be described later, OSD processor 1117 produces the corresponding signals OSD_RGB representing the on-screen display information previously stored or programmed in the memory 1127. For example, when a user enables an EPG, e.g., by activating a particular switch on remote control 1125, CPU 1112 enables processor 1117. In response, processor 1117 produces signals OSD_RGB representing the program guide data information previously extracted and already stored in memory, as discussed above. Processor 1117 also produces signal FSW indicating when the EPG is to be displayed.

Video signal processor (VSP) 1155 performs conventional video signal processing functions, such as luma and chroma processing. Output signals produced by VSP 1155 are suitable for coupling to a display device, e.g., a kinescope or LCD device (not shown in FIG. 1), for producing a displayed image. VSP 1155 also includes a fast switch for coupling signals produced by OSD processor 1117 to the output video signal path at times when graphics and/or text is to be included in the displayed image. The fast switch is controlled by control signal FSW which is generated by OSD processor 1117 in main microprocessor 1110 at times when text and/or graphics are to be displayed.

The input signal for VSP 1155 is signal PIPV that is output by picture-in-picture (PIP) processor 1140. When a user activates PIP mode, signal PIPV represents a large picture (large pix) into which a small picture (small pix) is inset. When PIP mode is inactive, signal PIPV represents just the large pix, i.e., no small pix signal is included in signal PIPV. PIP processor 1140 provides the described functionality in a conventional manner using features included in unit 1140 such as a video switch, analog-to-digital converter (ADC), RAM, and digital to analog converter (DAC).

As mentioned above, the display data included in the EPG display is produced by OSD processor 1117 and included in the output signal by VSP 1155 in response to fast switch signal FSW. When controller 1110 detects activation of the EPG display, e.g., when a user presses an appropriate key on remote control 1125, controller 1110 causes OSD processor 1117 to produce the EPG display using information such as program guide data from StarSight™ module 1160. Controller 1110 causes VSP 1155 to combine the EPG display data from OSD processor 1117 and the video image signal in response to signal FSW to produce a display including EPG. The EPG can occupy all or only a portion of the display area.

When the EPG display is active, controller 1110 executes an EPG control program stored in EEPROM 1127. The control program monitors the location of a position indicator, such as a cursor and/or highlighting, in the EPG display. A user controls the location of the position indicator using direction and selection keys of remote control 1125. Alternatively, the system could include a mouse device. Controller 1110 detects activation of a selection device, such as clicking a mouse button, and evaluates current cursor location information in conjunction with EPG data being displayed to determine the function desired, e.g., tuning a particular program. Controller 1110 subsequently activates the control action associated with the selected feature.

The process and displaying of a program guide in accordance with the present invention may be implemented using a combination of software and hardware. For example, referring to FIG. 1, display of an EPG may be implemented by software in memory such as EEPROM 1127. Activation of an EPG, e.g., by a user pressing an EPG related button on remote control 1125, causes CPU 1112 to execute the EPG software routine. As part of generating an EPG display, CPU 1112 also accesses EPG data and graphics that may be stored in StarSight™ module 1160 via the 12C bus. Under control of the EPG software routine stored in EEPROM 1127, CPU 1112 enables OSD processor 1117 which formats the EPG data into a form suitable for producing an OSD representing the EPG data and graphics. The OSD data produced by OSD processor 1117 is coupled to video signal processor (VSP) 1155 via signal lines OSD_RGB. A fast switch in VSP 1155 couples in the EPG OSD data to the output of VSP 1155 under control of signal FSW. That is, the software routine being executed by CPU 1112 determines when the EPG data is to be displayed (e.g., what portion of the display) and sets signal FSW to the appropriate state for causing the fast switch to couple the EPG data to the output.

An exemplary embodiment of the features of the system shown in FIG. 1 that have been described thus far comprises an ST9296 microprocessor produced by SGS-Thomson Microelectronics for providing the features associated with mP 1110; an M65616 picture-in-picture processor produced by Mitsubishi for providing the described basic PIP functionality associated with PIP processor 1140; and an LA7612 video signal processor produced by Sanyo for providing the functions of VSP 1155.

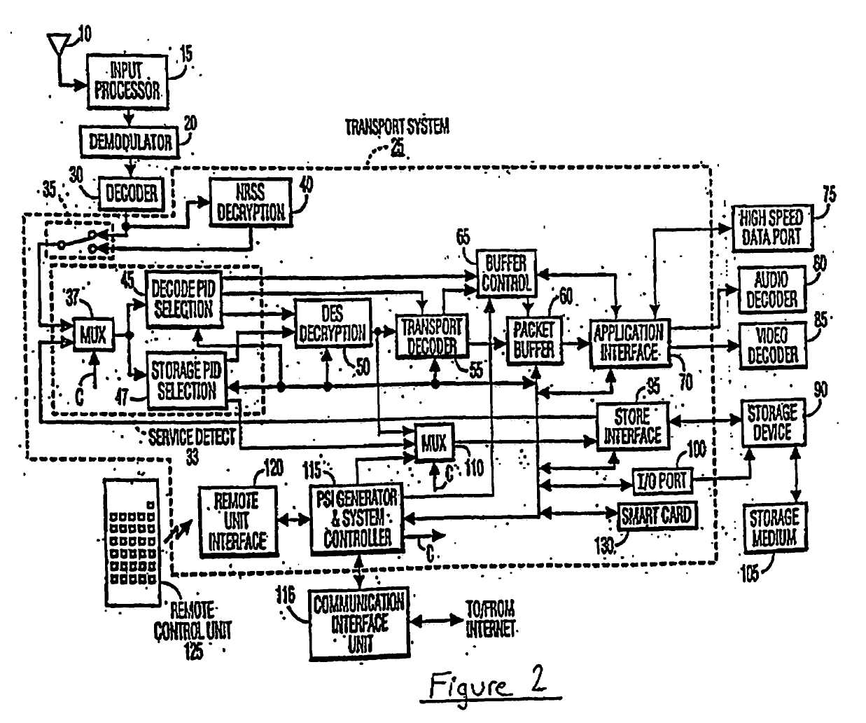

FIG. 2 shows another example of an apparatus capable of processing user commands, displaying the user interface screens of FIGS. 5-6, and performing searches of stored program guide records in accordance with the present invention. As described below, the apparatus shown in FIG. 2 is an MPEG compatible system for receiving MPEG encoded transport streams representing broadcast programs. However, the system shown in FIG. 2 is exemplary only. The user interface system described herein is also applicable to other types of digital signal processing devices including non-MPEG compatible systems, involving other types of encoded datastreams. For example, other devices include digital video disc (DVD) systems and MPEG program streams, and systems combining computer and television functions such as the so-called “PCTV.” Further, although the system described below is described as processing broadcast programs, this is exemplary only. The term “program” is used to represent any form of packetized data such as telephone messages, computer programs, internet data or other communications, for example.

In overview, in the video receiver system of FIG. 2, a carrier modulated with video data is received by antenna 10 and processed by unit 15. The resultant digital output signal is demodulated by demodulator 20 and decoded by decoder 30. The output from decoder 30 is processed by transport system 25 which is responsive to commands from remote control unit 125. System 25 provides compressed data outputs for storage, further decoding, or communication to other devices.

Video and audio decoders 85 and 80 respectively, decode the compressed data from system 25 to provide outputs for display. Data port 75 provides an interface for communication of the compressed data from system 25 to other devices such as a computer or High Definition Television (HDTV) receiver, for example. Storage device 90 stores the compressed data from system 25 on storage medium 105. Device 90, in a playback mode also supports retrieval of the compressed data from storage medium 105 for processing by system 25 for decoding, communication to other devices or storage on a different storage medium (not shown to simplify drawing).

In FIG. 2, a carrier modulated with video data received by antenna 10, is converted to digital form and processed by input processor 15. Processor 15 includes radio frequency (RF) tuner and intermediate frequency (IF) mixer and amplification stages for down-converting the input video signal to a lower frequency band suitable for further processing. The resultant digital output signal is demodulated by demodulator 20 and decoded by decoder 30. The output from decoder 30 is further processed by transport system 25.

Multiplexer (mux) 37 of service detector 33 is provided, via selector 35, with either the output from decoder 30, or the decoder 30 output further processed by a descrambling unit 40. Descrambling unit 40 may be, for example, a removable unit such as a smart card in accordance with ISO 7816 and NRSS (National Renewable Security Standards) Committee standards (the NRSS removable conditional access system is defined in EIA Draft Document IS-679, Project PN-3639). Selector 35 detects the presence of an insertable, compatible, descrambling card and provides the output of unit 40 to mux 37 only if the card is currently inserted in the video receiver unit. Otherwise selector 35 provides the output from decoder 30 to mux 37. The presence of the insertable card permits unit 40 to descramble additional premium program channels, for example, and provide additional program services to a viewer. It should be noted that in the preferred embodiment NRSS unit 40 and smart card unit 130 (smart card unit 130 is discussed later) share the same system 25 interface such that only either an NRSS card or a smart card may be inserted at any one time. However, the interfaces may also be separate to allow parallel operation.

The data provided to mux 37 from selector 35 is in the form of an MPEG compliant packetized transport datastream as defined in MPEG systems standard section 2.4 and includes program guide information and the data content of one or more program channels. The individual packets that comprise particular program channels are identified by Packet Identifiers (PIDs). The transport stream contains Program Specific Information (PSI) for use in identifying the PIDs and assembling individual data packets to recover the content of all the program channels that comprise the packetized datastream. Transport system 25, under the control of the system controller 115, acquires and collates program guide information from the input transport stream, storage device 90 or an internet service provider via the communication interface unit 116. The individual packets that comprise either particular program channel content or Program Guide information, are identified by their Packet Identifiers (PIDs) contained within header information. As discussed above, the program description contained in the program guide information may comprise different program descriptive fields such as title, star, rating, etc., relating to a program.

The user interface incorporated in the video receiver shown in FIG. 2 enables a user to activate various features by selecting a desired feature from an on-screen display (OSD) menu. The OSD menu may include an electronic program guide (EPG) as described above, and other features discussed below.

Data representing information displayed in the OSD menu is generated by system controller 115 in response to stored on-screen display (OSD) information representing text/graphics, stored program guide information, and/or program guide and text/graphics information received via the input signal as described above and in accordance with exemplary control programs to be shown in FIGS. 5-7, and to be discussed below. The software control programs may be stored, for example, in embedded memory (not shown) of system controller 115.

Using remote control unit 125 (or other selection means such as a mouse) a user can select from the OSD menu items such as a program to be viewed, a program to be stored (e.g., recorded), the type of storage media and manner of storage. System controller 115 uses the selection information, provided via interface 120, to configure system 25 to select the programs for storage and display and to generate PSI suitable for the selected storage device and media. Controller 115 configures system 25 elements 45, 47, 50, 55, 65 and 95 by setting control register values within these elements via a data bus and by selecting signal paths via muxes 37 and 110 with control signal C.

In response to control signal C, mux 37 selects either, the transport stream from unit 35, or in a playback mode, a datastream retrieved from storage device 90 via store interface 95. In normal, non-playback operation, the data packets comprising the program that the user selected to view are identified by their PIDs by selection unit 45. If an encryption indicator in the header data of the selected program packets indicates the packets are encrypted, unit 45 provides the packets to decryption unit 50. Otherwise unit 45 provides non-encrypted packets to transport decoder 55. Similarly, the data packets comprising the programs that the user selected for storage are identified by their PIDs by selection unit 47. Unit 47 provides encrypted packets to decryption unit 50 or non-encrypted packets to mux 110 based on the packet header encryption indicator information.

The functions of decryptors 40 and 50 may be implemented in a single removable smart card which is compatible with the NRSS standard. The approach places all security related functions in a removable unit that can easily be replaced if a service provider decides to change encryption techniques or to permit easily changing the security system, e.g., to descramble a different service.

Units 45 and 47 employ PID detection filters that match the PIDs of incoming packets provided by mux 37 with PID values pre-loaded in control registers within units 45 and 47 by controller 115. The pre-loaded PIDs are used in units 47 and 45 to identify the data packets that are to be stored and the data packets that are to be decoded for use in providing a video image. The pre-loaded PIDs are stored in look-up tables in units 45 and 47. The PID look-up tables are memory mapped to encryption key tables in units 45 and 47 that associate encryption keys with each pre-loaded PID. The memory mapped PID and encryption key look-up tables permit units 45 and 47 to match encrypted packets containing a pre-loaded PID with associated encryption keys that permit their decryption. Non-encrypted packets do not have associated encryption keys. Units 45 and 47 provide both identified packets and their associated encryption keys to decryptor 50. The PID look-up table in unit 45 is also memory mapped to a destination table that matches packets containing pre-loaded PIDs with corresponding destination buffer locations in packet buffer 60. The encryption keys and destination buffer location addresses associated with the programs selected by a user for viewing or storage are pre-loaded into units 45 and 47 along with the assigned PIDs by controller 115. The encryption keys are generated by ISO 7816-3 compliant smart card system 130 from encryption codes extracted from the input datastream. The generation of the encryption keys is subject to customer entitlement determined from coded information in the input data stream and/or pre-stored on the insertable smart card itself (International Standards Organization document ISO 7816-3 of 1989 defines the interface and signal structures for a smart card system).

The packets provided by units 45 and 47 to unit 50 are encrypted using an encryption technique such as the Data Encryption Standard (DES) defined in Federal Information Standards (FIPS) Publications 46, 74 and 81 provided by the National Technical Information Service, Department of Commerce. Unit 50 decrypts the encrypted packets using corresponding encryption keys provided by units 45 and 47 by applying decryption techniques appropriate for the selected encryption algorithm. The decrypted packets from unit 50 and the non-encrypted packets from unit 45 that comprise the program for display are provided to decoder 55. The decrypted packets from unit 50 and the non-encrypted packets from unit 47 that comprise the program for storage are provided to mux 110.

Unit 60 contains four packet buffers accessible by controller 115. One of the buffers is assigned to hold data destined for use by controller 115 and the other three buffers are assigned to hold packets that are destined for use by application devices 75, 80 and 85. Access to the packets stored in the four buffers within unit 60 by both controller 115 and by application interface 70 is controlled by buffer control unit 65. Unit 45 provides a destination flag to unit 65 for each packet identified by unit 45 for decoding. The flags indicate the individual unit 60 destination locations for the identified packets and are stored by control unit 65 in an internal memory table. Control unit 65 determines a series of read and write pointers associated with packets stored in buffer 60 based on the First-In-First-Out (FIFO) principle. The write pointers in conjunction with the destination flags permit sequential storage of an identified packet from units 45 or 50 in the next empty location within the appropriate destination buffer in unit 60. The read pointers permit sequential reading of packets from the appropriate unit 60 destination buffers by controller 15 and application interface 70.

The non-encrypted and decrypted packets provided by units 45 and 50 to decoder 55 contain a transport header as defined by section 2.4.3.2 of the MPEG systems standard. Decoder 55 determines from the transport header whether the non-encrypted and decrypted packets contain an adaptation field (per the MPEG systems standard). The adaptation field contains timing information including, for example, Program Clock References (PCRs) that permit synchronization and decoding of content packets. Upon detection of a timing information packet, that is a packet containing an adaptation field, decoder 55 signals controller 115, via an interrupt mechanism by setting a system interrupt, that the packet has been received. In addition, decoder 55 changes the timing packet destination flag in unit 65 and provides the packet to unit 60. By changing the unit 65 destination flag, unit 65 diverts the timing information packet provided by decoder 55 to the unit 60 buffer location assigned to hold data for use by controller 115, instead of an application buffer location.

Upon receiving the system interrupt set by decoder 55, controller 115 reads the timing information and PCR value and stores it in internal memory. PCR values of successive timing information packets are used by controller 115 to adjust the system 25 master clock (27 MHz). The difference between PCR based and master clock based estimates of the time interval between the receipt of successive timing packets, generated by controller 115, is used to adjust the system 25 master clock. Controller 115 achieves this by applying the derived time estimate difference to adjust the input control voltage of a voltage controlled oscillator used to generate the master clock. Controller 115 resets the system interrupt after storing the timing information in internal memory.

Packets received by decoder 55 from units 45 and 50 that contain program content including audio, video, caption, and other information, are directed by unit 65 from decoder 55 to the designated application device buffers in packet buffer 60. Application control unit 70 sequentially retrieves the audio, video, caption and other data from the designated buffers in buffer 60 and provides the data to corresponding application devices 75, 80 and 85. The application devices comprise audio and video decoders 80 and 85 and high speed data port 75. For example, packet data corresponding to a composite program guide generated by the controller 115 as described may be transported to the video decoder 85 for formatting into video signal suitable for display on a monitor (not shown) connected to the video decoder 85. Also, for example, data port 75 may be used to provide high speed data such as computer programs, for example, to a computer. Alternatively, port 75 may be used to output data to an HDTV decoder to display images corresponding to a selected program or a program guide, for example.

Packets that contain PSI information are recognized by unit 45 as destined for the controller 115 buffer in unit 60. The PSI packets are directed to this buffer by unit 65 via units 45, 50 and 55 in a similar manner to that described for packets containing program content. Controller 115 reads the PSI from unit 60 and stores it in internal memory.

Controller 115 also generates condensed PSI (CPSI) from the stored PSI and incorporates the CPSI in a packetized datastream suitable for storage on a selectable storage medium. The packet identification and direction is governed by controller 115 in conjunction with the unit 45 and unit 47 PID, destination and encryption key look-up tables and control unit 65 finctions in the manner previously described.

In addition, controller 115 is coupled to a communication interface unit 116 that operates in a manner similar to interface unit 1113 in FIG. 1. That is, unit 116 provides the capability to upload and download information to and from the internet. Communication interface unit 116 includes, for example, a modem for connecting to an internet service provider, e.g., via a telephone line or via a cable television line. The communication capability allows the system shown in FIG. 2 to provide email capability and internet related features such as web browsing in addition to receiving television programming.

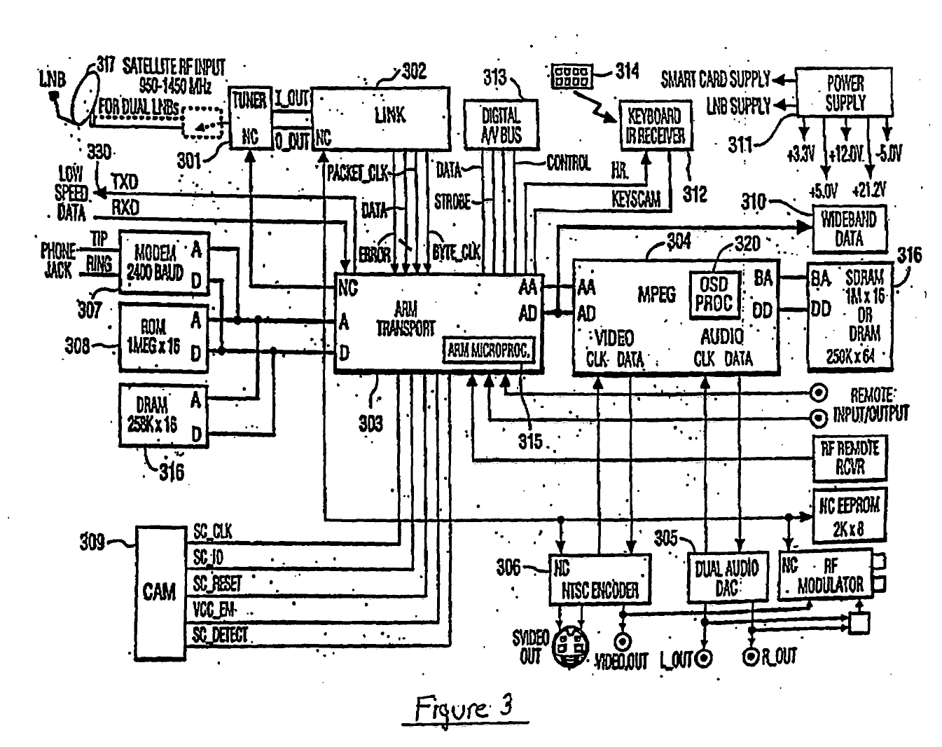

FIG. 3 is a specific implementation of an electronic device generally shown in FIG. 2 and described in detail above. FIG. 3 represents a satellite receiver set-top box, designed and manufactured by Thomson Consumer Electronics, of Indianapolis, Ind., USA, for receiving DIRECTV.R™. satellite service provided by Hughes Electronics.

As shown in FIG. 3, the set-top box has a tuner 301 which receives and tunes applicable satellite RF signals in the range of 950-1450 Mhz from a satellite antenna 317. The tuned analog signals are outputted to a link module 302 for further processing. Link module 302 is responsible for further processing of the analog tuned signals I_out and Q_out from tuner 301, including filtering and conditioning of the analog signals, and conversion of the analog signals into a digital output signal, DATA. The link module 302 is implemented as an integrated circuit (IC). The link module IC is manufactured by SGS-Thomson Microelectronics of Grenoble, France, and has Part No. ST 15339-610.

The digital output, DATA, from the link module 302 consists of compliant packetized data stream recognized and processable by the transport unit 303. The data stream, as discussed in detail in relation to FIG. 2, includes program guide data information and the data content of one or more program channels of the satellite broadcast service from DIRECTV™. As discussed above, program guide data contains information relating to the type of program (e.g., audio-only, video-only, etc.) as indicated, for example, by the “class” type.

The function of the transport unit 303 is the same as the transport system 25 shown in FIG. 2 and discussed already. As described above, the transport unit 303, processes the packetized data stream according to the Packet Identifiers (PID) contained in the header information. The processed data stream is then formatted into MPEG compatible, compressed audio and video packets and coupled to a MPEG decoder 304 for further processing.

The transport unit 303 is controlled by an Advanced RISC Microprocessor (ARM) 315 which is a RISC based microprocessor. The ARM processor 315 executes control software residing in ROM 308. Exemplary components of the software may be, for example, control programs shown in FIGS. 5-6 for processing user interface commands and displaying OSD information in accordance with aspects of the present invention as will be discussed below.

The transport unit 303 is typically implemented as an integrated circuit. For example, a preferred embodiment is an IC manufactured by SGS-Thomson Microelectronics and has a Part No. ST 15273-810 or 15103-65C.

The MPEG compatible, compressed audio and video packets from the transport unit 303 are delivered to a MPEG decoder 304. The MPEG decoder decodes the compressed MPEG datastream from the transport unit 303. The decoder 304 then outputs the applicable audio stream which can be further processed by the audio digital-to-analog converter (DAC) 305 to convert the digital audio data into analog sound. The decoder 304 also outputs applicable digital video data which represents image pixel information to a NTSC encoder 306. The NTSC encoder 306 then further processes this video data into NTSC compatible analog video signal so that video images may be displayed on a regular NTSC television screen. The MPEG decoder as described above may be implemented as an integrated circuit. One exemplary embodiment may be an MPEG decoder IC manufactured by SGS-Thomson Microelectronics having Part No. ST I3520.

Included in the MPEG processor 304 is an OSD processor 320. The OSD processor 320 reads data from SDRAM 316 which contains stored OSD information. OSD information corresponds to bitmap OSD graphics/text images. The OSD processor is capable of varying the color and/or translucency of each pixel of an OSD image under the control of the ARM microprocessor 315.

The OSD processor can also be responsible for generating a program guide under the control of the ARM processor 315. In the exemplary embodiment, upon detecting a user request to generate a guide display, the ARM microprocessor 315 processes the program guide data information obtained from a data stream provided by a program guide information provider and formats the guide data information into OSD pixel data corresponding to a “grid guide.” The OSD pixel data from the transport unit 303 is then forwarded to OSD processor 320 in the MPEG audio/video decoder 304 for generating the guide image.

A low speed data port 330 is used to connect to an IR-Blaster (not shown) for controlling a VCR for recording a program. As discussed before, an IR blaster is basically a programmable VCR remote control emulator controlled by the satellite receiver shown in FIG. 3. It is positioned in front of a VCR remote sensor of an attached VCR and will transmit commands such as “ON” and “RECORD” under the control of the satellite receiver at the appropriate time, according to the timer screen information entered by the users.

Additional relevant functional blocks of FIG. 3 include modem 307 which corresponds to the communication interface unit 116 shown in FIG. 2 for access to the internet, for example. Conditional Access Module (CAM) 309, corresponds to the NRSS decryption unit 130 shown in FIG. 2 for providing conditional access information. Wideband data module 310 corresponds to High Speed Data Port 75 shown in FIG. 2 for providing high speed data access to, for example, a HDTV decoder or a computer. A keyboard/IR Receiver module 312 corresponds to Remote Unit interface 120 shown in FIG. 2 for receiving user control commands from a user control unit 314. Digital AV bus module 313 corresponds to I/O port 100 shown in FIG. 2 for connection to an external device such as a VCR or a DVD player.

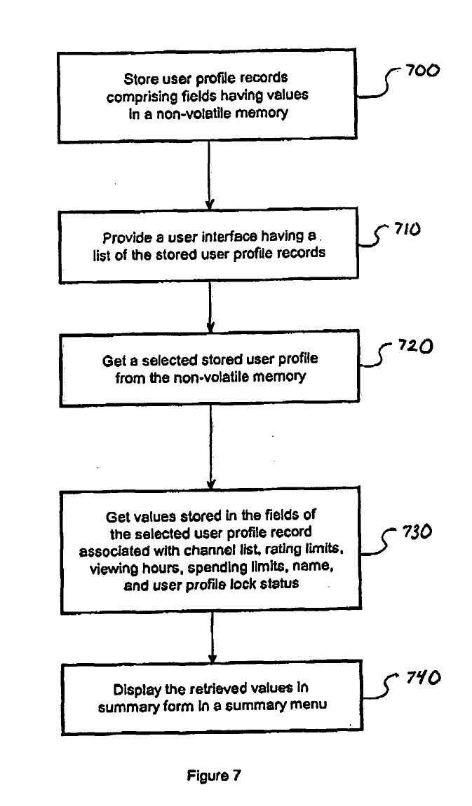

FIG. 7 is a high-level flow chart of an exemplary control program which according to the present invention, may be executed by any one of the apparatus shown in FIGS. 1-3, or any other suitably programmed control arrangement of an electronic host device. The term “electronic host device” as used herein is not limited to television receivers or personal computers, but rather encompasses hybrids thereof (e.g., PCTVs), cable television converter boxes, suitably equipped audiovisual program recorders (e.g., VCRs), satellite television and/or data signal converters, program guide receiving units, and the like, regardless of whether incorporated into a television receiver or personal computer or connected externally thereto. It will be appreciated that the process embodied in the exemplary control program may be implemented in hardware, software, or a combination thereof. A person skilled in the art would readily recognize from the flow chart and the following description that the control program when executed by any one of the systems described in FIGS. 1-3 or by other suitably programmed electronic host device will provide substantially the same feature and advantages in accordance with the present invention. Therefore, to avoid redundancy, the control program of FIG. 7 will be described below only with respect to the exemplary hardware implementation shown in FIG. 2 and the interfaces of FIGS. 5 and 6.

Application interface 70, under the control of the system controller 115, can generate user interfaces as shown in FIGS. 5 and 6. Preferably, the user interfaces of FIGS. 5 and 6 are generated in response to that particular interface being activated (e.g., a system owner activating a particular key on remote control 125 or making a selection in another user interface). In response to such activation, system controller 115 transfers user interface data to application interface 70. Application interface 70 then outputs the corresponding display information to the video decoder for display on display module 11 (FIG. 4).

System controller 115 performs step 700 of FIG. 7, storing user profile records comprising fields having values in a non-volatile memory. The details of how a user profile record is created and how it is stored in the non-volatile memory are explained in the above discussion regarding FIG. 5. As such, it will not be repeated here.

FIG. 6 illustrates an interface for selecting a previously created user profile to be edited according to the present invention. Display module 11 comprises display area 18 having user interface 600. User interface 600 comprises user profile editing cells 601-606, summary menu screen 607, help button 608, and back button 609. Each user profile editing cell 601-606 contains the name of a previously created user profile that was saved and stored as a record in the non-volatile memory a discussed above. User profile editing cells 601-606 effectively form a list of the all the stored user profile records that have been previously created by the system owner. As such step 710 of FIG. 7, providing a user interface having a list of the stored user profile records, is completed.

Upon highlighting one of the user profile editing cells 601-606 using remote control 125, system controller 115 is programmed to get the user profile record associated with the highlighted cell 601-606 from the non-volatile memory. This is step 720 of FIG. 7, getting a selected stored user profile record from the non-volatile memory. After getting the selected user profile record from the non-volatile memory, system controller 115 gets the values stored in the fields of the selected user profile record associated with channel list, rating limits, viewing hours, spending limits, name, and user profile lock status. By doing so, system controller 115 completes step 730 of FIG. 7.

System controller 115 then displays the retrieved values in summary menu screen 607 in a summary form (step 740 of FIG. 7). Specifically, the values are displayed in summary menu screen 607 next to headings that correspond to the field in which the value was stored.

Using the user interface of FIG. 6, a system owner can browse the settings of established user profiles by simply highlighting one of the cells 601-606, causing a summary of the user profile settings to appear. As such, the system owner can quickly evaluate whether the settings for any of the user profiles need to be modified. The system owner does not have to access the user interface of FIG. 5 (and then access each settings screen therein) as is necessary with prior art systems to make such an evaluation.

While the present invention is discussed above in relation to providing a summary display of the parental control settings for user profiles, the present invention is not limited to summarizing and displaying parental control values. The present invention can be used to display and summarize any type of user profile values, and in any combination. For example, the present invention can be used to summarize the personal settings established for a user profile, such as the identity of the default guide to be used, how the guide is to be sorted, color settings, translucency setting, animation settings, fetch settings, and whether “help” information is disabled or enabled. Personal settings are created, edited, and stored in a manner similar to parental control settings.

Moreover, the present invention of summarizing stored user profiles in a summary menu is not limited to those user interfaces used for editing established user profiles. The present invention can be implemented in any user interface in which a list of previously created user profiles exist. Thus, the foregoing discussion discloses and describes merely exemplary embodiments of the present invention. As will be understood by those familiar with the art, the invention may be embodied in other specific forms without departing from the spirit or essential characteristics thereof. Accordingly, the disclosure of the present invention is intended to be illustrative, but not limiting, of the scope of the invention, which is set forth in the following claims.

1. A method for controlling viewing of television programs comprising:
storing user profile records comprising fields having values in a memory;
providing a user interface having a list of the stored user profile records; and
upon user command, displaying a stored user profile record in summary form in the user interface.

2. The method of claim 1 wherein the user command comprises highlighting a stored user profile record in the list, resulting in the values of the highlighted stored user profile record being displayed in summary form in the user interface.

3. The method of claim 1 comprising upon a second user command, accessing a second user interface for editing the values of the displayed stored user profile record.

4. The method of claim 1 wherein the fields comprise one or more parental control fields.

5. The method of claim 4 wherein the one or more parental control fields are selected from the group consisting of ratings limit, viewing hour limit, spending limit, user profile locked status, and blocked and viewable channels.

6. The method of claim 1 wherein the fields comprise one or more personal settings fields.

7. The method of claim 6 wherein the one or more personal settings field are selected from the group consisting of default guide, guide sorting, color scheme, translucency, animation, fetch, and information help.

8. The method of claim 1 wherein the user profile record is displayed in summary form on the user interface in a format wherein the values are displayed next to headings corresponding to the fields.

9. An apparatus for controlling viewing of television programs comprising a memory storing user profile records;
a user interface for displaying a list of the stored user profile records and a summary of current settings for the stored user profile records;
means for entering user commands; and
wherein upon a user command, a summary of current settings for a stored user profile record is displayed in the user interface.

10. The apparatus of claim 9 wherein the user command is highlighting a stored user profile record in the list, resulting in a summary of the current settings for the highlighted stored user profile record being displayed in the user interface.

11. The apparatus of claim 9 comprising means for selecting the stored user profile record that is summarized in the user interface and accessing a second user interface for modifying the stored user profile record corresponding to the selected profile name.

12. The apparatus of claim 11 wherein the second user interface comprises means for saving the modified user profile record in the memory.

13. The apparatus of claim 9 comprising processor means for receiving user commands, getting stored user profile records from memory and generating corresponding display information in summary form, receiving and implementing user modifications to the stored user profile records, and storing the modified user profiles in the memory.
